(19) United States
(12) Patent Application Publication
(10) Pub. No.: US 2026/0310162 A1
(43) Pub. Date: Oct. 8, 2026

(54) ACQUISITION DEVICE AND ACQUISITION METHOD

(71) Applicant: FANUC CORPORATION, Minamitsuru-gun, Yamanashi (JP)

(72) Inventors: Yuki Nishiki, Oshino-mura, Minamitsuru-gun (JP); Junichi Tezuka, Oshino-mura, Minamitsuru-gun (JP)

(73) Assignee: FANUC CORPORATION, Minamitsuru-gun, Yamanashi (JP)

(21) Appl. No.: 19/490,248

(22) PCT Filed: Jun. 12, 2023
(86) PCT No.: PCT/JP2023/021719

§ 371 Date: Dec. 4, 2025

(51) Int. Cl. G05B 19/409; G05B 19/4155

(52) U.S. Cl. CPC G05B 19/409; G05B 19/4155

(57) ABSTRACT

Provided is an acquisition device including: an axis selection unit that selects at least two axes from among a plurality of axes of a machine; and a type selection unit that selects at least two types from among a plurality of types related to data for the at least two axes selected. This acquisition device further includes a data acquisition unit that acquires data on the basis of the at least two axes selected by the axis selection unit and the at least two types selected by the type selection unit.

### FIELD

The present disclosure relates to an acquisition device and an acquisition method.

### BACKGROUND

Industrial machines, such as machine tools and robots, are comprising a plurality of axes each driven by a plurality of motors. When adjusting at least one motor, plurality of types of data, such as the actual position and command position of the axis corresponding to that motor, may be acquired.

Japanese Patent No. 6001720 (Patent Literature 1) describes “In order to select acquired data which is acquired as a condition name input to the input box 51a as the data acquisition condition name 51, a table of the acquired data 55 is displayed using the acquired data addition button 56. Then, an axis type or a data type is input or selected.”

### CITATION LIST

### Patent Literature

[PTL 1] Japanese Patent No. 6001720

### SUMMARY

### Technical Problem

However, when it is desired to acquire plural types of data for the plurality of axes, it is necessary that the data acquisition setting operation be repeated plurality of times. Specifically, it is necessary that the acquisition setting operation be repeated a number of times equivalent to the product of the number of axes multiplied by the number of types of data. Repeating such an operation unnecessarily increases the time required for the setting operation and is cumbersome. Furthermore, when repeating the acquisition setting operation, there is a risk that the operator may input or select incorrectly.

Thus, there is a demand for an acquisition device which can simplify data acquisition setting operations.

### Solution to Problem

According to a first aspect of the present disclosure, there is provided an acquisition device, comprising an axis selection part for selecting at least two axes from a plurality of axes of a machine, a type selection part for selecting at least two types from a plurality of types related to data for the at least two axes selected by the axis selection part, and a data acquisition part for acquiring data based on the at least two axes selected by the axis selection part and the at least two types selected by the type selection part.

The objects, features, and advantages of the present disclosure will become more apparent from the following description of the embodiments in conjunction with the attached drawings.

### BRIEF DESCRIPTION OF DRAWINGS

FIG. 1 is a functional block diagram of an acquisition device based on a first embodiment of the present disclosure.

FIG. 2A is a view showing an example of the display part shown in FIG. 1.

FIG. 2B is a view showing an example of an acquisition table set by an acquisition setting operation.

FIG. 2C is a flowchart showing operation of the acquisition device.

FIG. 2D is a view showing a display part of a first modification example of the present disclosure.

FIG. 2E is a view showing a display part of another example of FIG. 2D.

FIG. 2F is a view showing a display part of a second modification example of the present disclosure.

FIG. 3 is a functional block diagram of an acquisition device based on a second embodiment of the present disclosure.

FIG. 4 is a functional block diagram of an acquisition device based on a third embodiment of the present disclosure.

FIG. 5A is a first view showing a display part of the prior art.

FIG. 5B is a second view showing the display part of the prior art.

FIG. 5C is a third view showing the display part of the prior art.

FIG. 6 is a functional block diagram of an acquisition device according to a fourth embodiment of the present disclosure.

### DESCRIPTION OF EMBODIMENTS

The embodiments of the present disclosure will be described below with reference to the attached drawings. In the drawings, corresponding constituent elements have been assigned common reference signs.

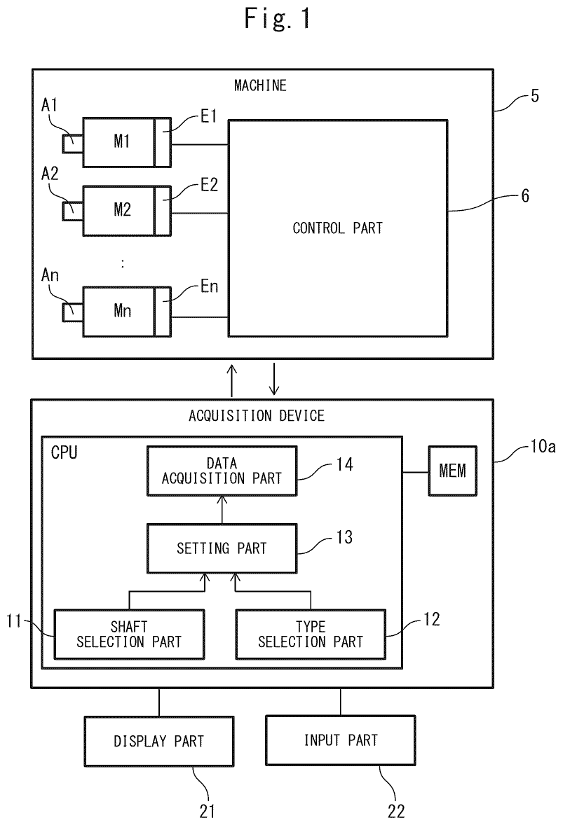

FIG. 1 is a functional block diagram of an acquisition device based on a first embodiment of the present disclosure. In FIG. 1, a configuration in which a machine 5 and an acquisition device 10a are connected is shown. The machine 5 comprises a plurality of drive parts M1 to Mn (the letter “n” is a natural number; the same applies hereinafter), such as motors, each of which includes an axis A1 to An. A typical machine 5 is, for example, a machine tool or a robot comprising the plurality of axes A1 to An. The plurality of drive parts M1 to Mn comprises respective detection parts E1 to En, such as encoders, for detecting the position and/or speed of each of the plurality of axes A1 to An. Though not illustrated in the drawing, the drive parts M1 to Mn may comprise various sensors, such as temperature sensors.

These plurality of drive parts M1 to Mn are controlled by a control part 6. The control part 6 controls the plurality of drive parts M1 to Mn using the detection results of the plurality of detection parts E1 to En. The control part 6 is a computer comprising a processor, memory, communication control part, etc., which are connected to each other via buses. When the machine 5 is a machine tool, the control part 6 may be a numerical control device. Furthermore, the control part 6 may be included inside the machine 5, or may be connected externally to the machine 5.

The acquisition device 10a is a computer comprising a central processing unit (CPU), a memory MEM, a communication control part, etc., which are connected to each other via buses. The memory MEM may be either a volatile memory or a non-volatile memory. The acquisition device 10a may be included inside the machine 5, or may be connected externally to the machine 5. Acquisition devices 10b, 10c, which are described later, are of generally the same configuration.

The CPU of the acquisition device 10a comprises an axis selection part 11 for selecting at least two axes from the plurality of axes A1 to An, and a type selection part 12 for selecting at least two types from a plurality of types related to data for the at least two axes selected by the axis selection part 11.

Further, the CPU of the acquisition device 10a comprises a setting part 13 for setting an acquisition target based on the at least two axes selected by the axis selection part 11 and the at least two types selected by the type selection part 12, and a data acquisition part 14 for acquiring data based on the acquisition target set by the setting part 13.

The axis selection part 11, the type selection part 12, the setting part 13, and the data acquisition part 14 of the CPU of the acquisition device 10a are functional modules realized by, for example, a computer program executed on the CPU. The computer program for executing the processes of the axis selection part 11, the type selection part 12, the setting part 13, and the data acquisition part 14 of the CPU of the acquisition device 10a may be provided in a form recorded on a computer-readable recording medium such as a semiconductor memory, a magnetic recording medium, or an optical recording medium. The same applies to the acquisition devices 10b, 10c, which are described later.

Further, a display part 21, such as a display, CRT, etc., for displaying various processes of the computer is connected to the acquisition device 10a. An input part 22, such as a mouse, keyboard, touch panel, etc., with which an operator inputs various operations is connected to the acquisition device 10a. Alternatively, a teaching operation panel (not illustrated) in which the display part 21 and the input part 22 are integrally configured may be connected to the acquisition device 10a.

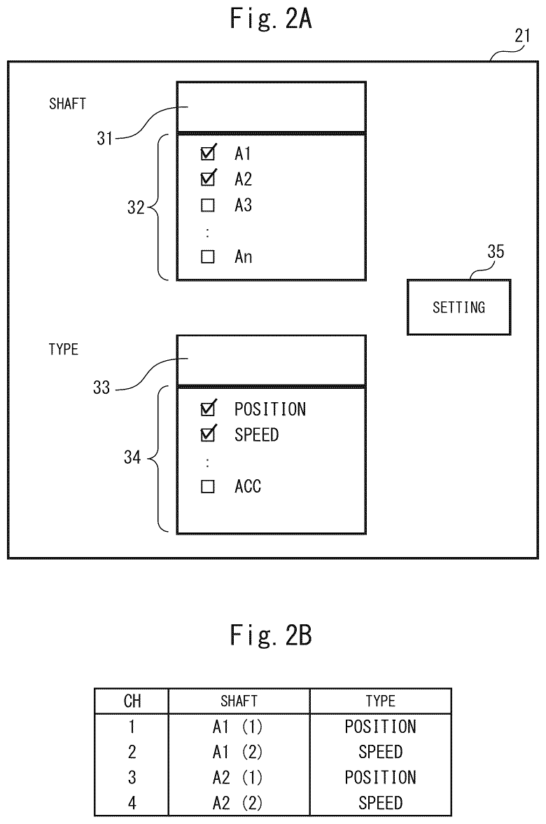

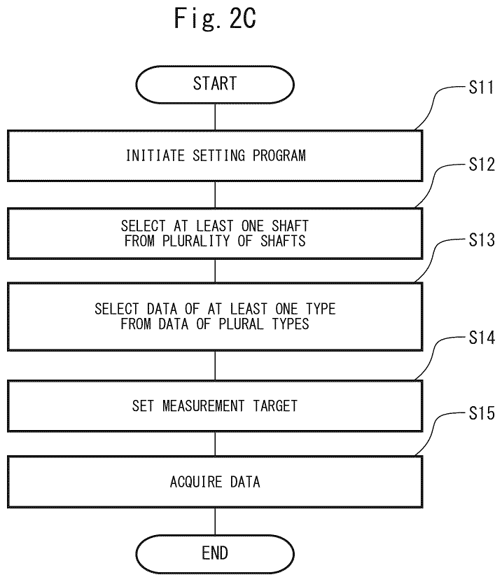

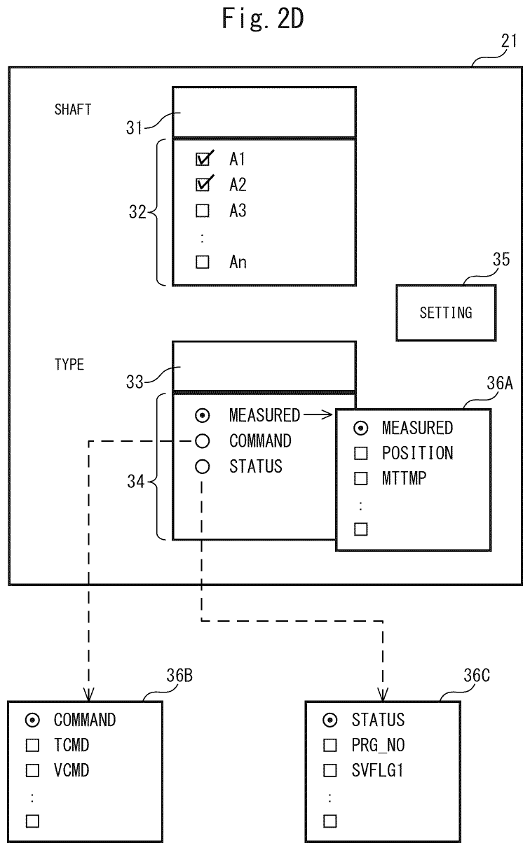

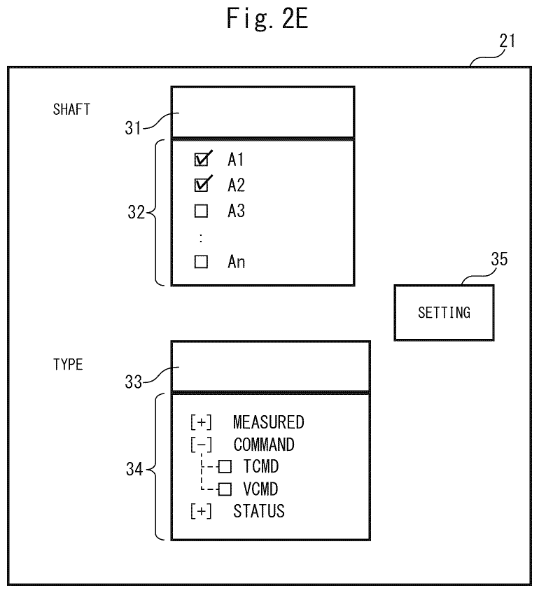

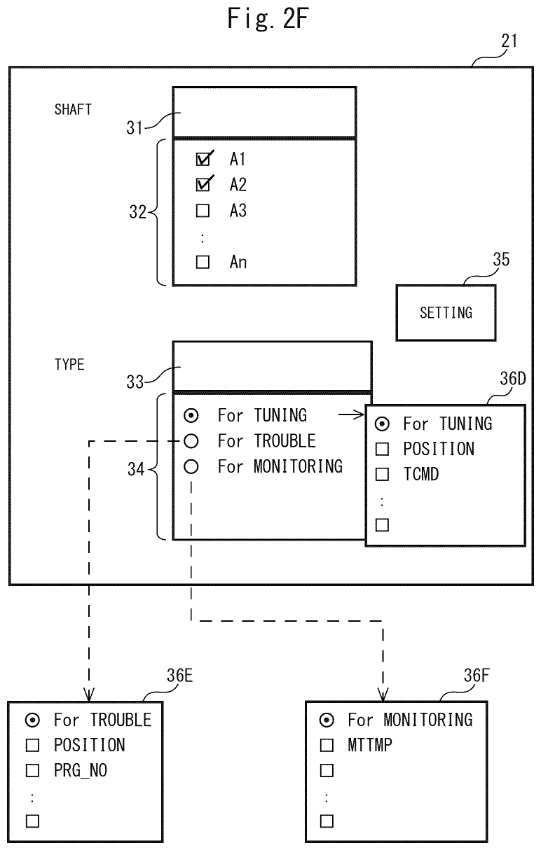

FIG. 2A is a view showing an example of the display part shown in FIG. 1, FIG. 2B is a view showing an example of an acquisition table set by the acquisition setting operation, and FIG. 2C is a flowchart showing the operation of the acquisition device. Settings and operations related to the acquisition device 10a will be described below with reference to FIGS. 2A to 2C. It is preferable that the machine 5 not be operating when the acquisition device 10a is set, and operations of the machine 5 be started after the acquisition device 10a is set. In this case, the acquisition device 10a can acquire data, which will be described later, in real time in conjunction with the operation of the machine 5.

Alternatively, when various data related to the plurality of axes A1 to An during operation of the machine 5 is automatically stored in the memory of the control part 6, the acquisition device 10a may be operated during operation of the machine 5 or after completion of operation. In this case, the acquisition device 10a acquires the data stored in the memory of the control part 6 thereafter.

In step S11 shown in FIG. 2C, the operator initiates a setting program for setting the acquisition device 10a, which is displayed on the display part 21. In FIG. 2A, an axis display area 31 and an axis selection area 32 for the plurality of axes A1 to An are displayed, and a type display area 33 and a type selection area 34 for the plurality of types are displayed. The axis display area 31, the axis selection area 32, the type display area 33, and the type selection area 34 are automatically displayed by initiating the setting program.

The axis display area 31 and the axis selection area 32 can be part of the functions of the axis selection part 11. The axis display area 31 is an area for displaying at least one of the plurality of axes A1 to An selected in the axis selection area 32. In the first embodiment, the axis display area 31 is blank immediately after initiation of the setting program.

The axis selection area 32 is an area for selecting at least one of the plurality of axes A1 to An. In the axis selection area 32 of FIG. 2A, check boxes corresponding to each of the plurality of axes A1 to An are arranged. When there are a large number of axes A1 to An, a scroll bar may be provided at the right end of the axis selection area 32.

Likewise, the type display area 33 and the type selection area 34 may be functions that are part of the type selection part 12. The type display area 33 is an area for displaying at least one of the plurality of types selected in the type selection area 34. In the first embodiment, the type display area 33 is blank immediately after initiation of the setting program.

The type selection area 34 is an area for selecting at least one of the plurality of types. In the type selection area 34 of FIG. 2A, check boxes corresponding to the plurality of types are arranged.

The plurality of types displayed in the type selection area 34 are, for example, the positions (POSITION) of the axes A1 to An, the speeds (SPEED) of the axes A1 to An, the acceleration (ACC) torque commands of the axes A1 to An, etc. Naturally, other check boxes for selecting other types of data may be arranged. When there are a large number of types, a scroll bar may be provided at the right end of the type selection area 34.

Next, in step S12, the operator uses the input part 22 to check a check box related to at least one desired axis from among the plurality of check boxes in the axis selection area 32. The selected axis is displayed in the axis display area 31. In FIG. 2A, two axes A1, A2 are selected.

Next, in step S13, the operator uses the input part 22 to check a check box related to at least one desired type from among the plurality of check boxes in the type selection area 34. The selected type is displayed in the type display area 33. In FIG. 2A, position and speed are selected as such types. Note that the axis selection area 32 and the type display area 33 may be configured for selecting the axes and types, respectively, by methods other than check boxes.

Next, in step S14, the operator presses the setting button 35 shown in FIG. 2A using the input part 22. The setting button 35 is a trigger for operating the setting part 13, whereby an acquisition target is set. As shown in FIG. 2B, the acquisition target set by the setting part 13 may be, for example, a settings table consisting of at least two selected axes and at least two selected types.

In the settings table of FIG. 2B, four channels CH1 to CH4 are set. Each channel includes a “axis” column and a “type” column. The names of the axes and the types selected by the axis selection part 11 and the type selection part 12 are automatically entered in the “axis” column and the “type” column, respectively.

In channel CH1, position as the type to be acquired is set for the axis A1. Likewise, in CH2, speed as the type to be acquired is set for the axis A1. Furthermore, in channel CH3, position as the type to be acquired is set for axis A2. Furthermore, in channel CH4, speed as the type to be acquired is set to speed for axis A2.

Both channels CH1 and CH2 are set so as to acquire data related to the axis A1, and both channels CH3 and CH4 are set so as to acquire data related to the axis A2. To distinguish between them, for example, the “axis” column for channel CH1 states “A1(1)” and the “axis” column for channel CH2 states “A1(2)”. The same is true for channels CH3 and CH4.

Next, in step S15, the data acquisition part 14 accesses the control part 6 of the machine 5 so as to collectively acquire a plurality of sets of data set in the settings table. When the data to be acquired is detection values, such as positions, speeds, or feedback values, stored in a memory (not illustrated) of the control part 6, it is preferable for the data acquisition part 14 to access such a memory. Furthermore, when the data to be acquired is command values, such as torque commands, stored in the operation program 6a of the control part 6, the data acquisition part 14 may access a storage part for the operation program.

The acquired data is stored in the memory MEM of the acquisition device 10a. These sets of data can be used to draw a graph in another window (not illustrated) of the display part 21. The numerical values of the acquired data may be written to appropriate positions in the settings table, for example, appropriate positions in the right hand of “type” column of the settings table.

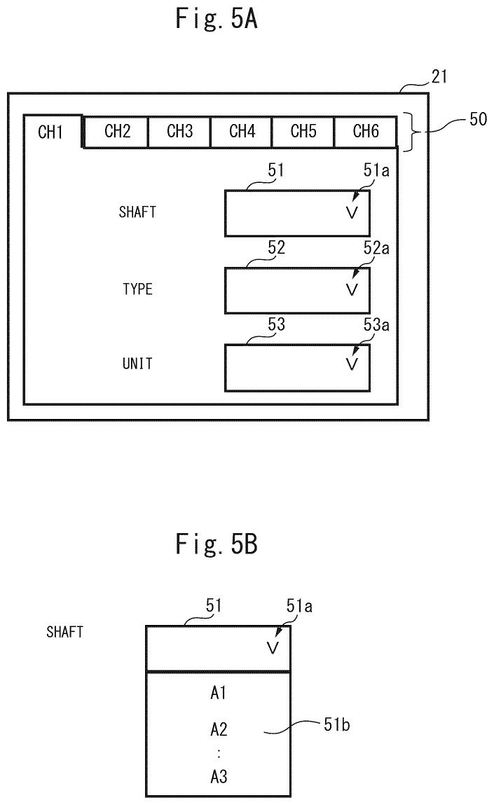

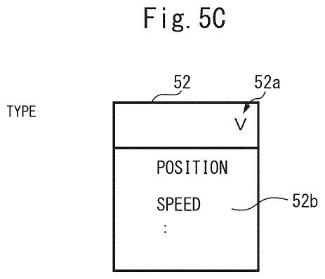

FIGS. 5A to 5C are views showing a display part of the prior art. As shown in FIG. 5A, the display part 21 of the prior art is provided with a tab column 50 for selecting one tab from a plurality of tabs. Each of the plurality of tabs in the tab column 50 corresponds to one channel.

Each tab includes at least an axis display area 51 for displaying the axis for which data is to be acquired, and a type display area 52 for displaying the type of data to be acquired. Furthermore, an axis selection portion 51a and a type selection portion 52a are arranged adjacent to the axis display area 51 and the type display area 52, respectively.

Note that in FIG. 5A, a unit display area 53 for displaying the unit of the type of data to be acquired and a unit selection portion 53a for selecting such a unit are shown. Since the unit display area 53 and the unit select portion 53a are not indispensable, description thereof has been omitted.

As shown in FIGS. 5B and 5C, the axis selection portion 51a and the type selection portion 52a are, for example, pull-down menus. When the operator clicks on the axis selection portion 51a using the input part 22, an axis selection area 51b is displayed adjacent to and below the axis display area 51. Likewise, when the operator clicks on the type selection portion 52a using the input part 22, a type selection area 52b is displayed adjacent to and below the type display area 52. The operator selects one axis for which data is to be acquired and one type of data from the axis selection area 51b and the type selection area 52b using a known method.

In this manner, the selection operation for one channel CH1 is completed. Next, the operator selects the next channel CH2 from the tab column 50 and repeats the same operation.

The operation of selecting specific data of a plurality of types for each of the plurality of axes will be considered. For the purpose of simplifying the description, the operation of selecting specific data of two types for each of the two axes A1, A2 will be described.

In the prior art, the operation of selecting one type of data for one axis, for example, the axis A1, is as follows.
(1) Select channel CH1 from tab field 50;
(2) Click on axis selection portion 51a;
(3) Select the axis for which data should be acquired from the axis selection area 51b;
(4) Click on type selection portion 52a; and
(5) Select the type of data to be acquired from the type selection area 52b.

Thus, in the prior art, the series of steps (1) to (5) described above must be repeated four times. Specifically, in the prior art, the operator must perform a total of 20 click operations to select two types of specific data for each of the two axes A1, A2. This type of operation is cumbersome and time-consuming, and may also lead to selection errors.

In contrast, in the present disclosure, when performing a selection operation for selecting two types of specific data for each of two similar axes A1, A2, it is sufficient to perform the following operations:
(1) Select the axis A1 from the axis selection area 32 shown in FIG. 2A;
(2) Select the axis A2 from the axis selection area 32 shown in FIG. 2A;
(3) Select one type from the type selection area 34 shown in FIG. 2A;
(4) Select another type from the type selection area 34 shown in FIG. 2A;
(5) Confirm with the setting button 35.

Specifically, in the present disclosure, the selection operation described is completed with only five clicks. Furthermore, the number of clicks does not increase significantly even when three or more axes and/or three or more types of data are selected. Conversely, in the prior art described above, it can be seen that the number of clicks increases significantly when three or more axes and/or three or more types of data are selected.

In this manner, in the present disclosure, the operation of selecting at least one axis from the plurality of axes and the operation of selecting at least one type from the selected at least one axis can be performed collectively. Thus, this is particularly advantageous for the data acquisition setting operation of selecting a plurality of types related to data for each of a plurality of axes, whereby such an operation can be made extremely simple. Therefore, in the present disclosure, the required time can be significantly reduced.

Note that FIG. 2D is a view showing a display part of a first modification example of the present disclosure. The type selection area 34 shown in FIG. 2D does not have check boxes, but instead has a plurality of selection parts, for example, three buttons. In the example shown in FIG. 2D, the first button is related to measurement values (abbreviated as “MEASURED” in FIG. 2D), the second button is related to command values (abbreviated as “COMMAND” in FIG. 2D), and the third button is related to status values (abbreviated as “STATUS” in FIG. 2D).

When a first button, for example, the button related to measurement values, is selected or double-clicked, a window 36A associated with the button pops up. A number of check boxes are arranged in the window 36A. Each of these check boxes corresponds to a specific measurement value. In FIG. 2D, check boxes related to POSITION (positions) of the axes A1 to An and MTTMP (temperatures of the windings of motors M1 to Mn) are shown in the window 36A.

Likewise, when the button related to command values is selected or double-clicked, a window 36B in which a number of check boxes are arranged likewise pops up. Each of these check boxes corresponds to a specific type of command value. In FIG. 2D, the check boxes related to TCMD (torque command values) and VCMD (velocity command values) of the axes A1 to An are shown in window 36B.

Likewise, when the button related to status values is selected or double-clicked, a window 36C in which plurality of check boxes are arranged likewise pops up. Each of these check boxes corresponds to a specific type of status value. In FIG. 2D, check boxes related to PRG_NO (program number) of the axes A1 to An and SVFLG1 (servo internal flag 1) are shown in window 36C. Note that “status value” means a value of at least a part of the internal status of the system shown in FIG. 1, etc.

In the configuration shown in FIG. 2D, the types of data are divided into a plurality of categories in the type selection area 34 in accordance with characteristics thereof. The operator first selects a desired category from the plurality of categories, and then selects a desired type from the desired category.

When the types of data are not categorized, the operator may mistakenly select a type in a certain category for a similar type in another category. Specifically, the operator may mistakenly select, for example, a measurement value related to a position for a command value related to a position. However, in the configuration shown in FIG. 2D, since the desired category is selected first and the desired type is then selected, the risk of the operator making an erroneous selection can be reduced.

Though not illustrated in the drawings, a desired large category may be selected from a plurality of large categories, a desired small category may then be selected from a plurality of small categories, and a desired type may then be selected. In this case, it is preferable that when one of a plurality of buttons in the window of a large category is selected or double-clicked, another window (not illustrated) for the small category having a plurality of other buttons pop up.

Depending on the format of the machine 5, there may be many types of data, for example, several tens of types. In such a case, a scroll bar (not illustrated) may be provided in the type selection area 34, and it may be necessary for the operator to move the scroll bar up and down to find the check box corresponding to the desired type.

In the configuration shown in FIG. 2D, since the operator first selects a category, each of the windows 36A to 36C from which a type should be selected is smaller than the type selection area 34 in the case where all types are included. Thus, even if each of the windows 36A to 36C includes a plurality of types, scroll bar operations can be minimized, or it is possible to eliminate scroll bars altogether. Thus, it can be seen that the burden on the operator can be reduced.

FIG. 2E is a view showing the display part of another example of FIG. 2D. In the other example, a select section as a plus button ([+]) is provided for each of the items of the measurement values, the command values, and the status values. As shown in FIG. 2E, when a specific plus button, for example, the plus button related to command values, is clicked, the plus button related to the command value changes to a minus button ([−]). At the same time, the data types associated with command values, for example, TCMD, VCMD, are expanded in a tree format. These data types may be accompanied by check boxes similar to those described above. When the minus button is clicked, the expanded data type is collapsed and becomes invisible. The same processing is performed when selecting other items. It is clear that the same effects can be obtained in such a case.

FIG. 2F is a view showing a display part of a second modification example of the present disclosure. The type selection area 34 shown in FIG. 2F does not have check boxes, but instead has a plurality of selection parts, for example, three buttons. In the example shown in FIG. 2F, the first button is for adjusting the machine 5 (abbreviated as “For TUNING” in FIG. 2F), the second button is for troubleshooting the machine 5 (abbreviated as “For TROUBLE” in FIG. 2F), and the third button is for monitoring the machine 5 (abbreviated as “For MONITORING” in FIG. 2F).

When a first button, for example, the button related to adjustment purposes, is selected or double-clicked, a window 36D associated with this button pops up. A number of check boxes are arranged in the window 36D. Each of these check boxes corresponds to a specific type of adjustment process. In FIG. 2F, check boxes related to the POSITION (positions) and TCMD (torque command values) of the axes A1 to An are shown in the window 36D.

Likewise, when the button related to troubleshooting purposes is selected or double-clicked, a window 36E with a number of check boxes likewise pops up. Each of these check boxes corresponds to a specific type of troubleshooting. In FIG. 2F, the check boxes related to the POSITION (positions) of the axis A1-An and PRG_NO (program number) are shown in the window 36E.

Likewise, when the button related to monitoring purposes is selected or double-clicked, a window 36F with plurality of check boxes pops up. Each of these check boxes corresponds to a specific type of monitoring process. In FIG. 2F, the check boxes related to MTTMP (winding temperatures of the motors M1 to Mn) of the axes A1 to An are shown in window 36F.

In the configuration shown in FIG. 2F, the types of data are divided into a plurality of categories in the type selection area 34 in accordance with the uses thereof. It should be understood that even in such a case, the same effects as described above can be obtained. As can be seen from FIG. 2F, a particular type of data, for example, POSITION, is used for a plurality of uses, and thus, may be represented in a plurality of categories.

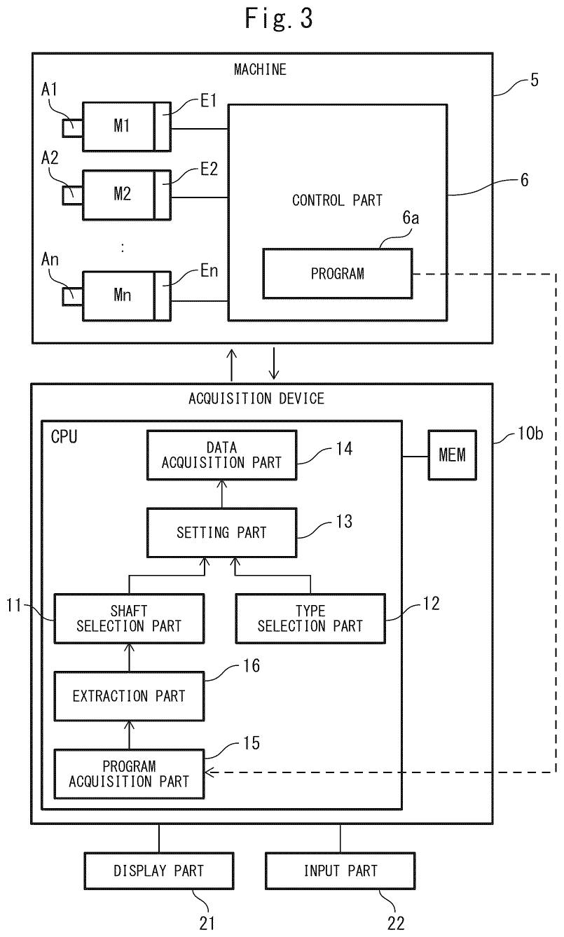

FIG. 3 is a functional block diagram of an acquisition device based on a second embodiment of the present disclosure. In FIG. 3, the CPU of the acquisition device 10b further comprises a program acquisition part 15 for acquiring an operation program 6a for operating the machine 5, and an extraction part 16 for extracting an axis, from among the plurality of axes A1 to An, indicated in the operation program 6a acquired by the program acquisition part 15. The operation program 6a is stored in a storage part of the control part 6.

The program acquisition part 15 and the extraction part 16 are functional modules realized by a computer program executed on, for example, the CPU. The computer program for executing the processes of the program acquisition part 15 and the extraction part 16 may be provided in a form recorded on a computer-readable recording medium such as a semiconductor memory, a magnetic recording medium, or an optical recording medium.

As can be seen from FIG. 3, the operation program 6a acquired by the program acquisition part 15 from the control part 6 is sent to the extraction part 16. The extraction part 16 refers to all lines of the operation program 6a and extracts all axes from the plurality of axes A1 to An commanded in the operation program 6a.

A part of the operation program 6a of an example will be described.

$$10 : \cdot G 91 \cdot G 94 ;$$

$$20 : \cdot N 1 \cdot G 04 \cdot X 1 . ;$$

$$30 : \cdot G 01 \cdot A 1 = 20. \cdot F 2000 \cdot ;$$

$$40 : \cdot G 01 \cdot A 2 = - 20. \cdot F 2000 \cdot ;$$

$$50 : \cdot G 01 \cdot A 1 = - 20. \cdot F 2000 \cdot ;$$

$$60 : \cdot G 01 \cdot A 2 = 20. \cdot F 2000 \cdot ;$$

$$70 : \cdot N 999 \cdot G 04 \cdot X 1 . \cdot ;$$

$$80 : \cdot M 99 \cdot ;$$

For example, “G01·A1=20.000·F2000” on line 30 of the operation program 6a described above means that the axis A1 is moved forward by 20 millimeters from its original position at a speed of 2000 mm/min. A similar description regarding the axis A1 is found on line 50. Further, descriptions regarding the axis A2 are found on lines 40 and 60. Furthermore, there are no such descriptions regarding any of axes A1 to An on lines 10, 20, 70, or 80.

In such a case, the extraction part 16 automatically extracts lines 30 to 60, which contain descriptions of the axis A1 or the axis A2. The axis selection part 11 then automatically selects the extracted axes as the axes for which data is desired to be acquired. The other processing is the same as that described above.

In this case, the selection operation in the axis selection area 32 shown in FIG. 2A is performed automatically, thereby reducing the burden on the operator and avoiding input errors due to human operation.

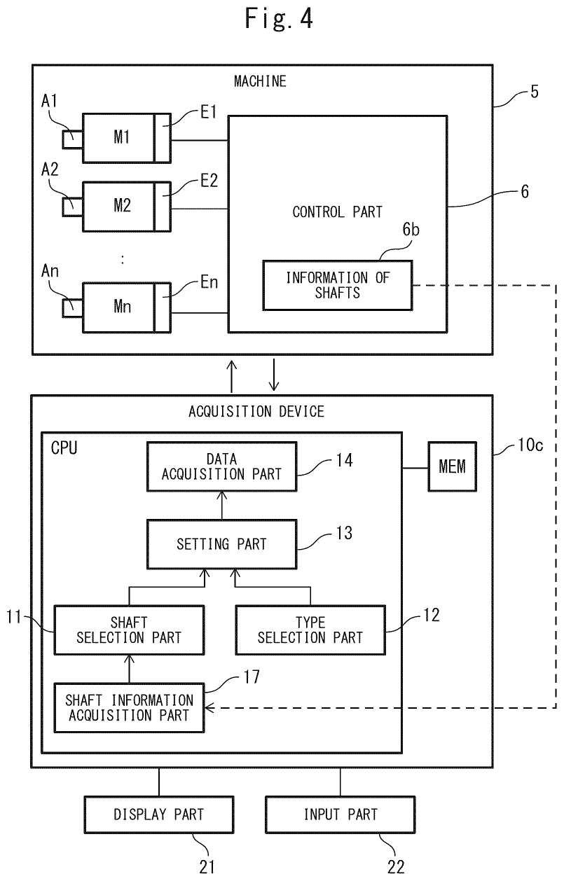

FIG. 4 is a functional block diagram of an acquisition device based on a third embodiment of the present disclosure. In FIG. 4, the CPU of the acquisition device 10c further comprises an axis information acquisition part 17 for acquiring information 6b of the plurality of axes A1 to An associated with the machine 5. The axis information acquisition part 17 is a functional module realized by a computer program executed on, for example, the CPU. The computer program for executing the processing of the axis information acquisition part 17 may be provided in a form recorded on a computer-readable recording medium such as a semiconductor memory, a magnetic recording medium, or an optical recording medium.

The information 6b of the plurality of axes A1 to An acquired by the axis information acquisition part 17 indicates the axes among the plurality of axes A1 to An included in the machine 5 which are connected to the control part 6. Even if the machine 5 includes the plurality of axes A1 to An, not all of the plurality of axes A1 to An are necessarily connected to the control part 6. The axis information acquisition part 17 acquires information only on the axes from among the plurality of axes A1 to An which are connected to the control part 6. Thus, the axis information 6b indicates the names of the axes among the plurality of axes A1 to An which are connected to the control part 6, for example, the axis A1. Such axis information 6b is stored in the storage part of the control part 6.

As can be seen from FIG. 4, the axis information 6b acquired by the axis information acquisition part 17 from the control part 6 is sent to the axis selection part 11. The axis selection part 11 automatically selects the axes for which data is desired to be acquired in accordance with the received axis information 6b. In other words, the axis selection part 11 selects all of the axes with names described in the axis information 6b as axes for which data is desired to be acquired. The other processing is the same as that described above.

As described above, in this case, the selection operation in the axis selection area 32 shown in FIG. 2A is performed automatically, thereby reducing the burden on the operator and avoiding input errors due to human operation.

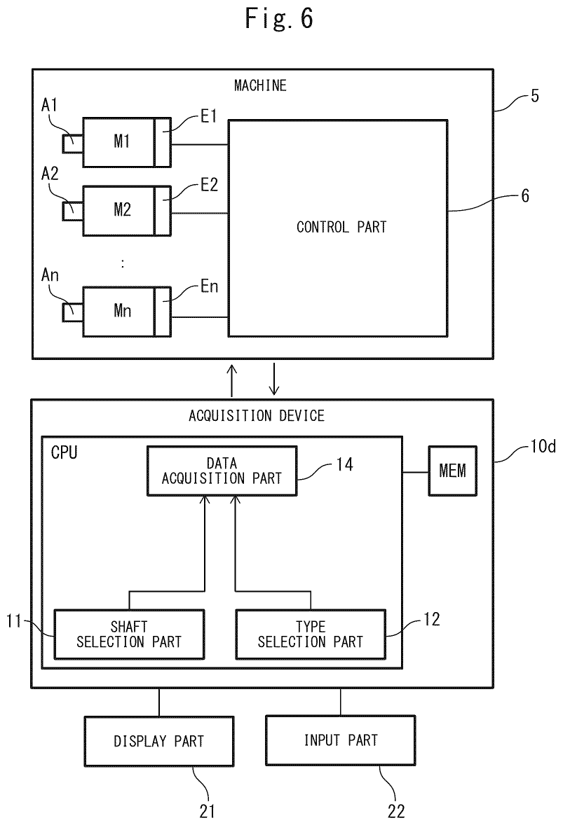

FIG. 6 is a functional block diagram of an acquisition device according to a fourth embodiment of the present disclosure. The acquisition device 10d shown in FIG. 6 does not comprise a setting part 13. Thus, the data acquisition part 14 directly acquires data based on the at least one axis selected by the axis selection part 11 and the at least one type of data selected by the type selection part 12, and stores the data in the memory MEM.

In this case, the acquisition target such as the settings table is not set. Further, step S14 shown in FIG. 2C is omitted. It should be understood that as a result, the desired data can be acquired more quickly. The configuration shown in FIG. 6 is also included in the scope of the present disclosure.

As an advantage of at least one of the embodiments described above, the data acquisition setting operation can be simplified. Further, the acquisition setting operation can be performed in a short time, whereby the burden on the operator and the occurrence of operational errors can be reduced.

Though the embodiments of the present disclosure have been described in detail, the present disclosure is not limited to the individual embodiments described above. Various additions, replacements, modifications, partial deletions, etc., to these embodiments can be made within the scope of the spirit of the invention, or within the scope of the idea and intent of the present invention derived from the contents described in the claims and their equivalents. For example, though the order of each operation and the order of each process are shown as examples in the embodiments described above, they are not limited to these. The same applies when numerical values or formulas are used in the description of the above-mentioned embodiments. Furthermore, appropriate combinations of some of the above-mentioned embodiments are included in the scope of the present disclosure.

In relation to the embodiments and modification examples described above, the following Addenda are disclosed.

### (Addendum 1)

An acquisition device, comprising:
an axis selection part for selecting at least two axes from a plurality of axes of a machine,
a type selection part for selecting at least two types from a plurality of types related to data for the at least two axes selected by the axis selection part, and
a data acquisition part for acquiring data based on the at least two axes selected by the axis selection part and the at least two types selected by the type selection part.

### (Addendum 2)

The acquisition device according to Addendum 1, further comprising a setting part for setting an acquisition target based on the at least two axes selected by the axis selection part and the at least two types selected by the type selection part, wherein
the acquisition part acquires data based on the acquisition target set by the setting part.

### (Addendum 3)

The acquisition device according to Addendum 1 or 2, wherein the axis selection part collectively selects the at least two axes, and the type selection part collectively selects the at least two types.

### (Addendum 4)

The acquisition device according to any one of Addenda 1 to 3, comprising a program acquisition part for acquiring an operation program for operating the machine, and
an extraction part for extracting an axis, from among the plurality of axes, indicated in the operation program acquired by the program acquisition part, wherein
the axis selection part selects at least two axes serving as the acquisition target based on the axis extracted by the extraction part.

### (Addendum 5)

The acquisition device according to any one of Addenda 1 to 3, comprising an axis information acquisition part for acquiring information of the plurality of axes associated with the machine, wherein
the axis selection part selects at least two axes serving as the acquisition target based on the information of the axes acquired by the axis information acquisition part.

### (Addendum 6)

An acquisition method, comprising the steps of:
selecting at least two axes from a plurality of axes of a machine,
selecting at least two types from a plurality of types related to data for the selected at least two axes, and
acquiring data based on the selected at least two axes and the selected at least two types.

### (Addendum 7)

The acquisition method according to Addendum 6, comprising the steps of:
setting an acquisition target based on the selected at least two axes and the selected at least two types, and
acquiring data based on the acquisition target.

### (Addendum 8)

The acquisition method according to Addendum 6 or 7, comprising collectively selecting the at least two axes and collectively selecting the at least two types.

### (Addendum 9)

The acquisition method according to any of Addenda 6 to 8, comprising acquiring an operation program for operating the machine,
extracting an axis, from among the plurality of axes, indicated in the operation program, and
selecting at least two axes serving as the acquisition target based on the extracted axis.

### (Addendum 10)

The acquisition method according to any of Addenda 6 to 8, comprising acquiring information of the plurality of axes associated with the machine, and
selecting at least two axes serving as the acquisition target based on the information of the axes.

### REFERENCE SIGNS LIST

5 machine
6 control part
6a program
6b axis information
10a, 10b, 10c, 10d acquisition device
11 axis selection part
12 type selection part
13 setting part
14 data acquisition part
15 program acquisition part
16 extraction part
17 axis information acquisition part
21 display part
22 input part
31 axis display area
32 axis selection area
33 type display area
34 type selection area
35 setting button
36A to 36F window
A1 to An axis
E1 to En detection part
M1 to Mn drive part
MEM memory

1. An acquisition device, comprising:
a processor, wherein the processor is configured to
select at least two axes from a plurality of axes of a machine,
select at least two types from a plurality of types related to data for the selected at least two axes, and
acquire data based on the selected at least two axes and the selected at least two types.

2. The acquisition device according to claim 1, the processor is further configured to set an acquisition target based on the selected at least two axes and the selected at least two types, and
acquire data based on the set acquisition target.

3. The acquisition device according to claim 1, wherein the processor is configured to collectively select the at least two axes, and collectively select the at least two types.

4. The acquisition device according to claim 1, wherein the processor is further configured to acquire an operation program for operating the machine, and
extract an axis, from among the plurality of axes, indicated in the acquired operation program and,
select at least two axes serving as the acquisition target based on the extracted axis.

5. The acquisition device according to claim 1, wherein the processor is further configured to acquire information of the plurality of axes associated with the machine, and,
select at least two axes serving as the acquisition target based on the acquired information of the axes.

6. An acquisition method, comprising the steps of:
selecting at least two axes from a plurality of axes of a machine,
selecting at least two types from a plurality of types related to data for the selected at least two axes, and
acquiring data based on the selected at least two axes and the selected at least two types.

7. The acquisition method according to claim 6, comprising the steps of:
setting an acquisition target based on the selected at least two axes and the selected at least two types, and
acquiring data based on the acquisition target.

8. The acquisition method according to claim 6, comprising collectively selecting the at least two axes and collectively selecting the at least two types.

9. The acquisition method according to claim 6, comprising acquiring an operation program for operating the machine,
extracting an axis, from among the plurality of axes, indicated in the operation program, and
selecting at least two axes serving as the acquisition target based on the extracted axis.

10. The acquisition method according to claim 6, comprising acquiring information of the plurality of axes associated with the machine, and
selecting at least two axes serving as the acquisition target based on the information of the axes.
